(19) United States
(12) Patent Application Publication
(10) Pub. No.: US 2008/0011988 A1
(43) Pub. Date: Jan. 17, 2008

(54) Activated silicon-containing-aluminum complex flame retardant and method for flame-proofing

(76) Inventor: Matthew Feller, Tenafly, NJ (US)

Correspondence Address: Matthew Feller, 2150 Center Ave., Fort Lee, NJ, 07024, US

(21) Appl. No.: 11/488,169

(22) Filed: Jul. 14, 2006

(51) Int. Cl. C09K 21/00

(52) U.S. Cl. 252/601

(57) ABSTRACT

An activated silicon-containing aluminum complex flame-proofing agent containing minor amounts of halogen, silicon, oxygen and hydrogen. The silicon being present in amounts of at least trace and having a hexagonal structure; the ratio oxygen to hydrogen in the complex usually being 16:18 and the process for making such complex comprises the steps of treating substantial pure aluminum with acid, then with mercury, then with a halogen acid again to form a slurry. The slurry is then applied on paper, paper pulp, cellulose pulp, plywood, clothing, textiles and any structural porous material for flame producing same. Coincidentally, when applied to certain toxic compounds and complexes in a certain way, it renders them non-toxic.

This application is related to Fred B. Bernat's U.S. Pat. Ser. No. 275,801 filed Jun. 22, 1981 for Activated Silicon-Containing Aluminum Complex and Method of Preparation Thereof.

### RELATED U.S. APPLICATION DATA

| | | |
|---|---|---|
| Continuation of Ser. No. 312,512 | Oct. 19, 1981 | Now abandoned |
| Continuation of Ser. No. 4,548,841 | Oct. 22, 1985 | Now abandoned |
| INT. CL. | | CO9D/5/14 |

| | |
|---|---|
| U.S. CL. | 427/372.2; 106/15.05; 106/18.12; 106/18.26; 427/397/7; |
| | 427/439 |
| Field Of Search | 106/15.05; 18.12, 18.26 427/383.1 397.7.439, 372.2 |

### REFERENCES CITED-US DOCUMENTS

| | | | |
|---|---|---|---|
| 4,247.410 | January 1981 | Bernat | 252/305 |
| 4,277.355 | January 1981 | Farcnik | 106/15.05 |
| 4,382.025 | May 1983 | Sallay | 106/15.05 |

### STATEMENT REGARDING FEDERALLY SPONSORED RESEARCH OR DEVELOPMENT

Not applicable.

### REFERENCE TO SEQUENCE LISTING, A TABLE OR A COMPUTER PROGRAM LISTING COMPACT DISK APPENDIX

Not applicable

### BACKGROUND OF THE INVENTION

In the U.S. Pat. Ser. Nos. 795,115 and 810,103, it is started that the structure of aluminum can be changed by chemical and electrochemical attack. The cylindrical or spherical shape of the silicon trace material was found to change the hexagonal shape as a consequence of attack by the “free chlorine” of the slurry when such was applied to an ordinary aluminum foil. (U.S. Pat. No. 795,115). It is believed that the same change in structure occurs in the silicon particles contained in the aluminum particles suspended in the slurry due to the interaction of the mercury-treated aluminum with the hydrochloric acid solution. This change in structure which can be observed in the finished, oxygenated solid fuel (U.S. Pat. No. 810,103) is also believed to be significant, i.e. it furnishes some understanding of what has and does take place which enable the subject composition to function as a fuel proofing agent.
(b) Free “activated” aluminum suspended probably as a colloid, containing hexagonally structured silicon and also additionally containing traces of chlorine, hydrogen and oxygen entrapped therein.

The unusual properties of the slurry may possibly be explainable as a consequence of “Van der Waal's forces” or the well known ability of particles in colloidal suspension to attract and retain on their surface dissolved substances and solvent molecules, i.e. to have molecules present in the solution even in ionic form become entrapped in or adhered on the particulate matter of the slurry or colloid. Whatever is the explanation the slurry is a critical medium for fireproofing.

Although the present invention has been described with references to particular embodiments and examples, it will be apparent to those skilled in the art that variations can be made.

### BRIEF SUMMARY OF THE INVENTION

The usefulness of the complex of the present invention will extend virtually to any application where such flame proofing would be advantageous. For example, the complex of this invention will affect the fireproofing and/or thermal insulation of building materials, textile, carpets, paper products and many other organic flammable products.

Furthermore, the same complex of this invention is capable of breaking up certain toxic compounds and complexes, rendering them totally non-toxic.

Moreover, the subject complex is non-polluting, nontoxic and safe environmentally, having no adverse impact of any kind in the atmosphere and water. It is non-corrosive.

In addition to its usefulness in making the complex, the slurry is also useful in preparation of other products such as “PROPELLANT” (U.S. Pat. No. 795,115) and “FUEL” (U.S. Pat. No. 810,103).

### BRIEF DESCRIPTION OF THE SEVERAL VIEWS OF THE DRAWING

For a better understanding of the invention, reference will now by made to the accompanying drawings, wherein;

FIG. 1 is a schematic sectional elevational view of one embodiment of stage 1 of the process of the present invention.

FIG. 2. is a schematic view similar to FIG. 1. showing another optional embodiment of stage 1 process of the present invention.

FIG. 3 is a schematic view similar to FIG. 1., showing the formation of the slurry in the HCL bath in stage two of the process of the present invention. In this embodiment, the aluminum is disposed substantially equidistant from the sides and bottom of the vessel.

FIG. 4 is a depiction of the structure of the untreated, inactive silicon found in inactivated form in the aluminum.

FIG. 5 is a depiction of the hexagonal structure of the silicon of the complex formed in the stages two and three of the process of the present invention in the slurry.

### DETAILED DESCRIPTION OF THE INVENTION

The activated-silicon containing aluminum complex of this invention can be conveniently prepared, utilizing a six stage process, although the process is not to be narrowly construed as being limited to such. The first stage, the preparation of a form of aluminum which can be termed “phase one” can typically be carried out as follows:

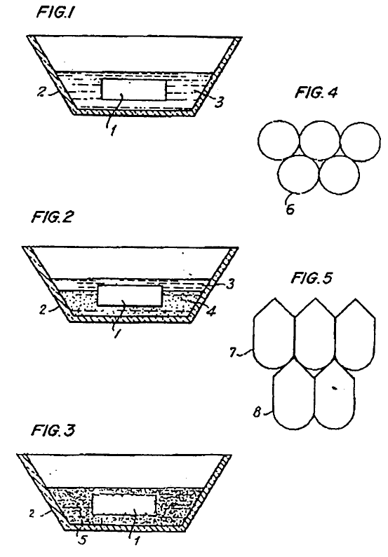

Utilizing the apparatus of FIG. 1 an aluminum bar or rod (1) is placed as shown in a vessel (2), the latter preferably of glass, and a thin layer of hydrochloric acid (3) is placed slightly, covering the aluminum. In this context the shape of aluminum is not narrowly critical. However, a bar or rod shape is generally preferred. The purpose of the acid treatment is to inhibit the formation of oxide on the aluminum surface. HCL is usually the acid employed for this purpose.

It is further important that the aluminum be substantially pure, on the order of, but not limited, to about 99.94% pure and also contain amounts of silicon on the order of trade about 60 to about 150 ppm. As a practical matter, whether the aluminum is sufficiently pure can be empirically determined since, if there is an abrupt rise in temperature, this indicates oxide formation and that the aluminum starting material was not sufficiently pure. Therefore, the purposes of this application, the term “substantially pure aluminum” denotes that degree of purity which is empirically determinable to be capable of being used in the process of this invention.

The aluminum is then contacted or coated with mercury, preferably placing such in a bath of the same in a similar type apparatus, in the presence of any oxygen—gas-containing atmosphere, such as air. In either of these preliminary steps, the temperature is not narrowly critical, but should not be such as to encourage oxide formation and/or chlorine gas. Ambient temperature is satisfactory.

If desired, the acid and mercury contact can be made simultaneously as shown in FIG. 2. In this figure the aluminum (1) is immersed in the acid bath (3) and the heavier mercury bath (4), the HCL forming a layer on the bath of mercury.

Whether the apparatus on FIG. 1 or 2 or other suitable apparatus is used, the length of time of contact with the mercury can be minimal, on the order of between fifteen and thrity seconds; longer contact, however is not detrimental. Within the context of this invention, the mercury acts only as a catalyst, which effects a change in the aluminum structure. As indicated above this changed structure is “phase one.”

The formation of “phase two” is the second stage in the process of this invention. This stage involves the formation of a slurry comprising phase one immersed in an acidic solution containing halogen. Particularly preferred among the suitable halogen solution is hydrochloric acid.

The slurry can be formed in a number of ways and the method thereof is not critical in and of itself. For example, after contact with the mercury bath, the thus-treated aluminum rod or bar is then immersed in another vessel, containing a bath of HCL. The latter should have a normality of about 1 Normal to about 2 Normal, but the actual range of concentration is empirical. When phase one, which is soluble in HCL to some extent is immersed in the acid solution, a rather viscous slurry white in color is formed. The slurry begins as a cloudy suspension and becomes increasingly dense. This is the consequence of particulate growth in and on the mercury treated and activate aluminum rod or bar of phase on. This growth is shown in FIG. 3, wherein the thick slurry (5) is denoted as forming in the acid bath. As more and more particles form, the slurry becomes more and more viscous.

Depending on the size of the aluminum bar or the amount of HCL present, the formation of the slurry can continue up to the entire consummation of the phase one aluminum material. However as a practical matter, the reaction will usually stop before the aluminum bar is consumed completely because the slurry will become too dense for further growth to occur. At this point, the thick slurry thus formed can be removed, partly or completely; additional HCL is then added and slurry formation continued. As a practical matter, the viscosity of the slurry can be as low as 10,000 cps. For most efficient use, such viscosity should be between about 12,000 cps and 16,000 cps.

This slurry is “phase two”. IN the formation thereof pursuant to the preparation of the complex, the temperature is important, that is between ambient and not more than about 30 degrees Centigrade, preferably between 22 degrees Centigrade and 25 degrees Centigrade. It should be noted that a sudden adverse rise in temperature of the reaction environment at this point could again mean that the aluminum starting material was not sufficiently pure.

Alternatively, though less desirably, the slurry can also be made “in situ” in the embodiment represented by FIG. 2. As shown in FIG. 2, the aluminum bar or rod is covered by HCL but is also partly submerged in the source of mercury. Optionally, the HCL needs not continue to cover the aluminum after oxide formation thereon is prevented or inhibited. A portion of the aluminum can be exposed above the surface. In either case, whether the HCL continues to cover the surface of the aluminum or not, a growth of some kind of complex occurs. This growth, itself, in this embodiment, is not the “phase

While the aforesaid temperature gradients are important when forming the slurry preparatory to the subsequent formation of the complex. It should be noted that the slurry itself can also be formed using somewhat higher temperatures, on the order of up to 40 degrees centigrade, and also starting with aluminum of slightly less purity.

The next stage in the process of forming the final complex, i.e. stage three is to adjust the pH so that the chlorine defined within the said particles of the slurry becomes active; “active” have meaning potentially unstable but not to the extent that the chlorine is liberated as chlorine gas. In this regard, it is desirable that the pH level of the slurry ultimately reside at a pH of about 3.0±0.2. At this juncture, it could be noted that if the viscosity of the slurry is between about 12,000 and 16,000 cps, the slurry will contain between about 1.5 and about 3.0% aluminum suspended therein in elemental form.

The increase or decrease of the pH is accomplished by treating the phase two materials with a strong hydroxide such as Na OH or KOH in case of increase, and with HCL in case of decrease. The normality is not critical, but usually can be between about 2 and 3 Normal concentration. The increase or decreased pH slurry can be termed “phase three”. The slurry is now ready to be applied as a fireproof agent on the selected objects.

“Phase four” consists of selecting and impregnating the flammable objects with the said adjusted slurry. While the range is enormous, we will mention some basic materials in every day use. Paper, paper pulp, cellulose pulp, plywood, clothing, textiles etc. All of these materials have to be provided with a sufficient capillarity—porosity in order to be able to absorb the slurry of the phase three.
a) Paper, carton or corrugated carton; the mentioned materials could be immersed in the slurry, or sprayed on with, and then dried. Room temperature is sufficient, however any elevated temperature, in order to speed up the drying process would be acceptable. Depending on the papers quality and the way of application, the paper (or carton) could be also prepared to be strongly tension resistant and also to be almost transparent. Exposed to a normal flame, the paper and carton will char, without any flame or sparks and without releasing any toxic or polluting substances in the atmosphere
b) Paper pulp: the paper pulp should be immersed in the slurry, squeezed under pressure, dried completely. Used as an insulator between two flammable layers such as a wooden wall or divider, the pulp becomes not only a heat-cold insulator, but a fire protector on the layer opposite the one on which the fire starts.
c) Cellulose pulp: the cellulose pulp should be immersed in the slurry, squeezed under pressure, and while still wet, spread in a thing layer between two veneers of plywood while in production. Once the veneer is posted over the pulp, considerable pressure should be applied through callender rollers or similar methods. In a period between 12 and 18 hours, the capillary channels of the veneer will soak up the slurry from the pulp, rendering this fireproof not only the center layer, but also the whole plywood as such.
d) Plywood: under c) as illustrated the preferable way how to produce a fireproof plywood. However if the plywood is already produced, it is still possible to fireproof the said finished plywood sheets, provided that the said plywood is provided with capillary channels sufficiently large in order to absorb the slurry when partially, sidewise immersed in it. No additional callender-roller pressure needed to be applied.
e) Clothing and textiles: the slurry has to be mixed with a light hydrocarbon, not necessarily chlorinated, in proportion preferable 1:3 but said proportion could be extended up to 1:5. The hydrocarbons such as mineral spirits, light mineral oil etc., are required in order to give the fabrics structure the necessary flexibility and elasticity. Like the paper(a) the fabrics will obtain also a considerably increased tensile strength.

This invention can be further illustrated by the following examples. Unless otherwise indicated all percentages are by weight.

### EXAMPLE 1

### Formation of the Slurry

500 grams of aluminum rod, having not more than 0.1% impurities was placed in 36 inch long shallow glass vessel as exemplified by FIG. 1. At a temperature of 20 degrees Centigrade, the aluminum was contacted with 3N hydrochloric acid in amounts sufficient to cover the aluminum rod. Thereafter the aluminum rod was removed from the first HCl bath and immersed in a mercury bath for approximately 20 seconds under moist (about 30 percent relative humidity) air atmospheric conditions. There also being a layer of HCL covering the mercury bath. The mercury contacted aluminum ro was then reimmersed in a bath of 2N HCL. At this point, the rod was positioned equidistant from the sides and bottom of the vessel. A growth was observed on the immersed surface of aluminum on all sides thereof. The aluminum bar also begins to dissolve in the HCL bath.

Also immediately, a milky white cloud began to appear. After about * hours, slurry begins to be discernible. The temperature was kept below 30 degrees Centrigrade. The reaction continued until all of the aluminum bar was consumed. Before the bar was consumed, however the slurry became so thick the reaction was severely inhibited. This occurred after about 48 hours. This thick slurry was then removed and fresh HCL added. This was continued until the dissolution of the aluminum was completed. The slurry had a pH of 3.5. The pH of the slurry was then adjusted to 3.0±0.2 by increasing the hydrogen ion content by addition of HCL.

### EXAMPLE 2

### Application of the Slurry

An amount of about 20 Kg of cellulose pulp is immersed in the slurry at the room temperature. Then squeezed with a suitable apparatus, so that the actually retained amount of th slurry in the pulp is about ˜3-4% by weight. Immediately the soaked pulp is spread in a 2 inches thick layer between the veneers of a sheet of a plywood. The same plywood sheet is then placed between the rollers of a callender machine under pressure. In about 48 hours the capillary channels of the veneers are soaking up the slurry from the pulp in sufficient quantity in order to be fireproof. The color or polish of the veneer is in no way affected by this procedure.

### Utility as Fireproofing Agent

As a group the existent fire retardant because of their compositions is under severe attack by environmental agencies. Beside the limited efficiencies, they are also irritants and many times toxic either while burning or while contacting the skin. None of the existing commercially available products are fire fireproof. There are only fire retardant at the best.

The complex of this invention meets the need. The object provided with the necessary capillarity channels becomes completely fireproof under fire of normal intensity. Under normal intensity is intended a flame or source of flame derived from wood, coal or liquid gas, gasoline or any other hydrocarbon. Even exposed to flame produced by special very high temperature chemicals like in a blowtorch, welding apparatus etc. the said product is still highly fire retardant. Furthermore, it is non-reactive, nonpolluting and indifferent to ozone. It is applicable to an extremely broad range of commercial products without changing or affecting their physical aspects or chemical composition. Moreover, in use, the subject inventive material has controllable parameters within accepted temperature/product requirements, as well as industry and government regulations. It is easily manageable, non-toxic or irritant and totally safe for the environment.

1) A composition for flame proofing flammable articles comprising activated silicon containing aluminum particles prepared by the steps of:
a) contacting aluminum metal containing at least trace amounts of silicon with an acid of the type which will remove oxide coating from and inhibit oxide formation thereon.
b) Simultaneously or thereafter contacting said aluminum with mercury or a source of mercury.
c) Immersing said mercury contacted aluminum metal in an acid bath at ambient temperature to not more than about 40 degrees Centrigrade, where by particles are formed on the metal which on mixing with the acid bath form the slurry.
d) adjusting the pH of the slurry between 4.5 and 5.0

2) the composition according to claim 1). Where in the acid of steps a) and c) is HCL.

3) A method for flame-proofing flammable materials and articles which comprises:
a) contacting said materials and articles with suspension comprising activated silicon containing aluminum metal containing at least trace amounts of silicon with an acid of the type which will remove oxide and coating from and inhibit oxide formation thereon; simultaneously or thereafter contacting said aluminum with mercury or a source of mercury; immersing said mercury contacted aluminum metal in an acid bath at ambient temperature to not more than about 40 degrees Centigrade., whereby particles formed on the metal which on mixing with the acid bath form the slurry; adjusting the pH of said slurry to 4.5-5.0;
b) drying the said suspension soaked or sprayed on articles.

4) The method according to claim 3) wherein said materials are selected from the group consisting of paper pulp, cellulose pulp, cardboard, etc.
